(19) United States
(12) Patent Application Publication
(10) Pub. No.: US 2005/0076951 A1
(43) Pub. Date: Apr. 14, 2005

(54) Pressure actuated valve

(76) Inventor: John M. Gray, Cincinnati, OH (US)

Correspondence Address: DINSMORE & SHOHL, LLP, 1900 CHEMED CENTER, 255 EAST FIFTH STREET, CINCINNATI, OH, 45202, US

(21) Appl. No.: 10/958,558

(22) Filed: Oct. 5, 2004

Related U.S. Application Data
(60) Provisional application No. 60/508,897, filed on Oct. 6, 2003.

(51) Int. Cl. G05D 11/00

(52) U.S. Cl. 137/115.16

(57) ABSTRACT

A pressure actuated valve is provided including a valve body having a fluid inlet chamber, an actuation chamber, and an outlet. The chambers and the outlet are configured for selective fluid communication with one another. A plunger is disposed within at least a portion of the actuation chamber for selective movement between open and closed positions. A sealing surface is situated adjacent to the actuation chamber and is correspondingly configured to effectively seal with the plunger in its closed position to block fluid communication from the fluid inlet chamber to the outlet. A biasing member is associated with the plunger and is configured to normally bias the plunger toward the open position. The plunger is configured to move into the closed position when pressure in the actuation chamber reaches a predetermined pressure setpoint. A condenser system for a fuel storage tank system having a pressure actuated valve is also provided.

### RELATED APPLICATION

The present application claims priority of U.S. Provisional Application Ser. No. 60/508,897 filed Oct. 6, 2003 and hereby incorporates the same Provisional Application by reference.

### TECHNICAL FIELD

The present invention relates to a pressure actuated valve. More particularly, a pressure actuated valve includes a pressure actuated plunger that selectively blocks the passage of fluid through the valve.

### BACKGROUND OF THE INVENTION

Condenser systems involve the pressurization of gas into liquid. In addition to other components, many condenser systems incorporate an accumulator vessel for temporary storage of condensed liquid. In certain of these systems, particularly those in which it is desirable to dispense the condensed liquid into a relatively unpressurized area, a valve can be employed to selectively facilitate the release of condensed liquid from the accumulator vessel. In many such systems, the valve must remain substantially closed during the condensation process, but can be opened when the condensation process is stopped in order to release condensed liquid from the accumulator vessel. The valve is typically closed again before the condensation process is resumed. In this regard, a selectively actuatable valve would be particularly applicable.

One suitable valve for use in this role involves an electromechanically actuated solenoid valve. This solenoid valve can be electrically closed prior to the beginning of the condensation process, but can then be electrically opened when the condensation process ends or to selectively drain the accumulator vessel to prevent overfill. In this manner, the solenoid valve can maintain necessary pressure within the accumulator vessel during the condensation process, but can allow the condensed liquid to drain from the accumulator vessel after the condensation process ends. Although this solenoid valve can function well for this application, it can be cumbersome and expensive. Furthermore, integrating such a valve into an electronic control system can be quite time consuming. For example, solenoid valves require electrical power for operation, and often must be specially packaged to withstand harsh environmental conditions and to be appropriately isolated from the fluid of an intended application.

Accordingly, there is a need for a pressure actuated valve that is compact, inexpensive, efficient, reliable and simple to install.

### SUMMARY OF THE INVENTION

It is an aspect of the present invention to provide a pressure actuated valve that is compact, inexpensive, efficient, reliable and simple to install.

In one exemplary embodiment of the present invention, a pressure actuated valve includes a valve body having first and second ends and having a fluid inlet chamber, an actuation chamber and an outlet. The chambers and the outlet are configured for selective fluid communication with one another, and the fluid inlet chamber is provided adjacent to one of the first and second ends. The actuation chamber is provided adjacent to the other of the first and second ends. A plunger is disposed within at least a portion of the actuation chamber for selective movement between open and closed positions. A sealing surface is situated adjacent to the actuation chamber and is correspondingly configured to effectively seal with the plunger in its closed position to block fluid communication between the fluid inlet chamber and the outlet. A biasing member is associated with the plunger and is configured to normally bias the plunger toward its open position. The plunger is configured to move into its closed position when pressure in the actuation chamber reaches a predetermined pressure setpoint.

In another exemplary embodiment of the present invention, a pressure actuated valve includes a valve body having first and second ends and having a fluid inlet chamber, an actuation chamber and an outlet. The chambers and the outlet are configured for selective fluid communication with one another. The fluid inlet chamber is oriented to receive fluid in a first flow direction, and the fluid inlet chamber is provided adjacent to one of the first and second ends. The actuation chamber is spaced from the fluid inlet chamber and is provided adjacent to the other of the first and second ends. The actuation chamber is configured to pass fluid in a second flow direction, wherein the second flow direction is different from the first flow direction. A passage in the valve body provides fluid communication between the fluid inlet chamber and the actuation chamber. A plunger is disposed within at least a portion of the actuation chamber for selective movement between open and closed positions. The plunger is configured for movement toward its closed position in the same direction as the second flow direction. A sealing surface is situated adjacent to the actuation chamber and is correspondingly configured to effectively seal with the plunger in its closed position to block fluid communication between the fluid inlet chamber and the outlet. A biasing member is associated with the plunger and is configured to normally bias the plunger toward its open position. The plunger is configured to move into its closed position upon pressure in the actuation chamber reaching a predetermined pressure setpoint.

In yet another exemplary embodiment of the present invention, a condenser system for a fuel storage tank system is provided. The condenser system has a pressure actuated valve for selectively releasing condensed fuel. The valve includes a valve body having a fluid inlet chamber, an actuation chamber, and an outlet. The chambers and the outlet are configured for selective fluid communication with one another. A plunger is disposed within at least a portion of the actuation chamber for selective movement between open and closed positions. A sealing surface is situated adjacent to the actuation chamber and is correspondingly configured to effectively seal with the plunger in its closed position to block fluid communication between the fluid inlet chamber and the outlet. A biasing member is associated with the plunger and is configured to normally bias the plunger toward its open position. The plunger is configured to move into its closed position when pressure in the actuation chamber reaches a predetermined pressure setpoint.

One advantage of the present invention is its provision of a pressure actuated valve that is compact, inexpensive, efficient, reliable and simple to install. Additional aspects, advantages, and novel features of the invention will be set forth in part in the description that follows, and in part will become apparent to those skilled in the art upon examination of the following, or may be learned with the practice of the invention. The aspects and advantages of the invention may be realized and attained by means of the instrumentalities and combinations particularly pointed out in the appended claims.

### BRIEF DESCRIPTION OF THE DRAWINGS

While the specification concludes with claims particularly pointing out and distinctly claiming the present invention, it is believed that the same will be better understood from the following description taken in conjunction with the accompanying drawings in which:

FIG. 1 is an elevational view depicting a valve in accordance with one exemplary embodiment of the present invention;

FIG. 2 is an exploded elevational view depicting the exemplary valve of FIG. 1;

FIG. 3 is a top plan view depicting the exemplary valve body of FIGS. 1-2;

FIG. 4 is a bottom plan view depicting the exemplary valve body of FIGS. 1-2;

FIG. 5 is a cross-section of the exemplary valve body taken along section line 5-5 in FIG. 3;

FIG. 6 is an enlarged elevational view depicting the exemplary plunger of FIG. 2;

FIG. 7 is a bottom plan view depicting the exemplary plunger of FIGS. 2 and 6; and

FIG. 8 is a cross-section of the exemplary plunger taken along section line 8-8 in FIG. 7.

### DETAILED DESCRIPTION OF EXEMPLARY EMBODIMENTS

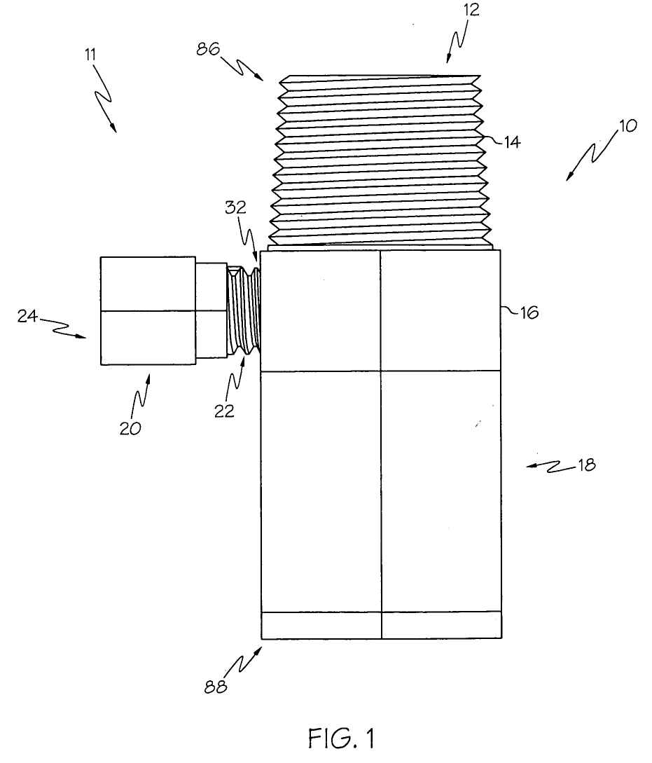

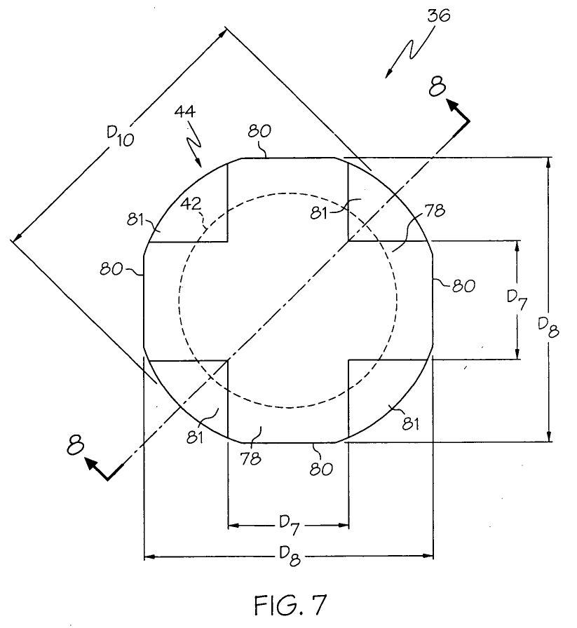

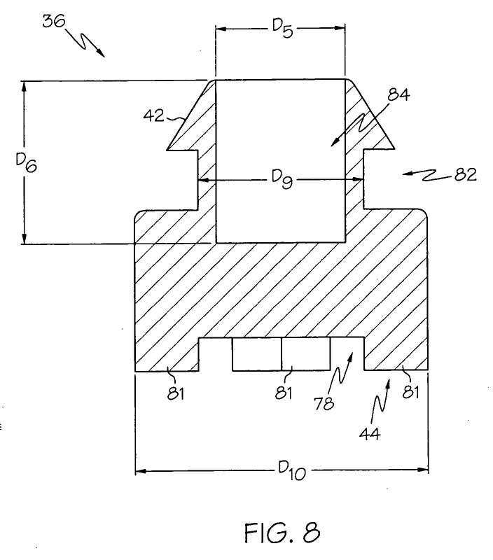

The present invention and its operation is hereinafter described in detail in connection with the views and examples of FIGS. 1-8, wherein like numbers indicate the same or corresponding elements throughout the views. These embodiments are shown and described only for purposes of illustrating examples of elements of the invention, and should not be considered as limiting on alternative structures or assemblies that will be apparent to those of ordinary skill in the art. Referring to FIG. 1, an exemplary valve 11 is shown to include a valve body 10, a cap 18, and a fitting 20. Valve body 10 includes an inlet 12 for receiving fluid from an associated fluid source, such as from an accumulator vessel or condenser arrangement. Threads 14 or other connection arrangements can be disposed adjacent to inlet 12 to facilitate interconnection of valve body 10 with the associated fluid source or with a pipe or other passage leading to the associated fluid source.

A grip portion 16 might be provided integrally with valve body 10. Grip portion can have a faceted outer configuration, such as knurling or some other structure to facilitate assembly, disassembly, installation and/or removal of cap 18. For example, grip portion 16 might be gripped by a wrench when threads 14 of valve body 10 are being threaded into an orifice of the associated fluid source (e.g., into an accumulator vessel).

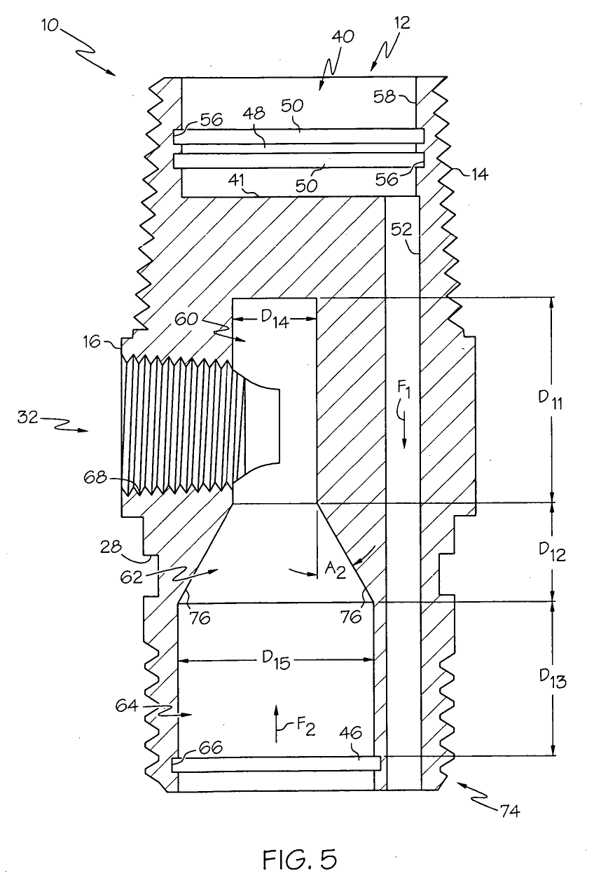

In one exemplary embodiment, as depicted in FIG. 1, valve 11 can have a first end 86 disposed near inlet 12, a second end 88 disposed oppositely from inlet 12, and an outlet 32 disposed between the first and second ends 86, 88. Outlet 32 can be configured to dispense fluid to a suitable receptacle and can be provided with threads (e.g., 68 in FIG. 5), such as for engaging a threaded portion 22 of fitting 20 in a substantially fluid tight manner. It should be appreciated that pipe thread compound, Teflon tape, or some other substance might be provided at the engagement between outlet 32 and fitting 20 in order to facilitate a quality seal therebetween. Fitting 20 can include an outlet 24 for interfacing a hose or tubing, for example. It should be understood, however, that a hose or tubing might alternatively directly interface outlet 32 with or without use of any such fitting 20.

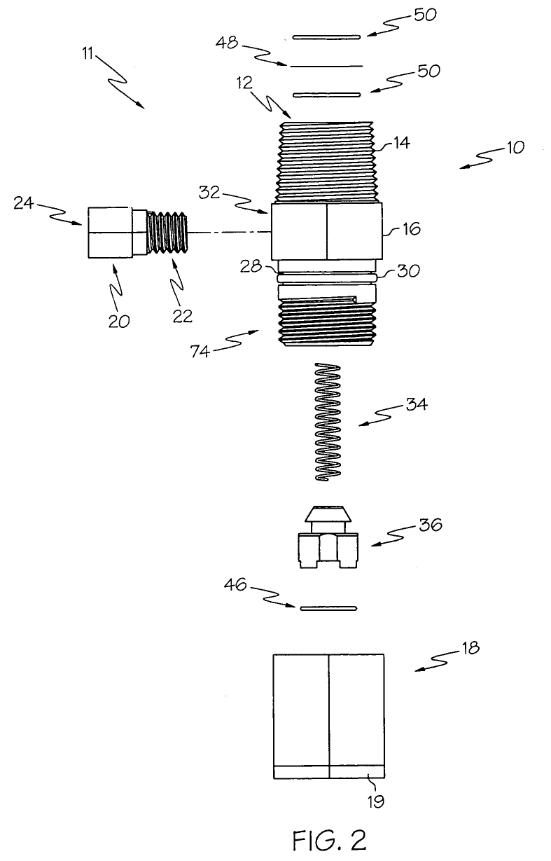

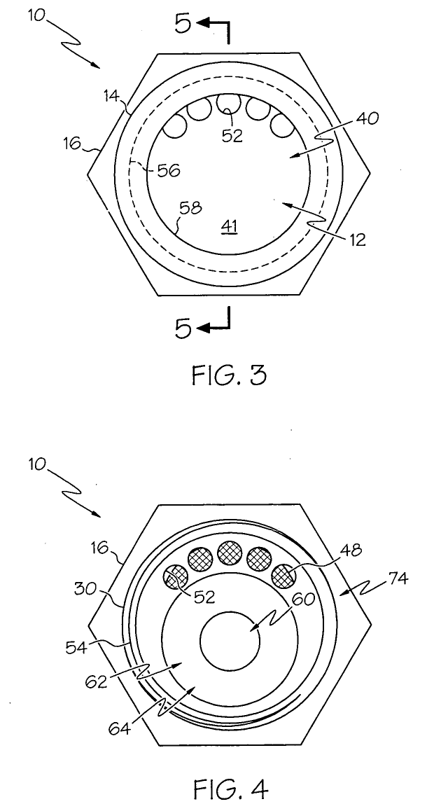

FIG. 2 depicts an exploded view of valve 11 in which certain internal components of valve 11 are better shown. FIGS. 3-5 also show additional details of exemplary valves, as will be discussed. For example, FIG. 2 depicts cap 18 as having been unthreaded or otherwise disconnected from valve body 10. A retaining ring 46 is shown as being removable from valve body 10. When valve 11 is fully assembled, retaining ring 46 can be associated with valve body 10, such as through its insertion into a channel (e.g., 66 in FIG. 5). When so inserted, retaining ring 46 can serve as a stopping member to retain a plunger 36 at least partially within valve body 10, even when cap 18 is removed. However, when retaining ring 46 is removed from valve body 10 (as shown in FIG. 2), plunger 36 is free to escape from valve body 10. When plunger 36 is removed from valve body 10 as shown in FIG. 2, a biasing member (e.g., spring 34) can also be removed from valve body 10.

To reassemble valve 11, spring 34 can be inserted into spring chamber 60 of valve body 10, plunger 36 can then be inserted into valve body 10, and then retaining ring 46 can be inserted into valve body 10. Cap 18 can then be installed onto threaded end 74 of valve body 10. When cap 18 is fully installed onto threaded end 74, a sealing element (e.g., an o-ring 30 disposed within a channel 28 in the outer perimeter of valve body 10) can be provided to ensure a fluid-tight connection between cap 18 and valve body 10. In this manner, cap 18 can be associated with one end (e.g., second end 88) of valve 11, and can be operative to seal that end.

Valve body 10, plunger 36, cap 18, retaining ring 46 and the biasing member (e.g., spring 34) can be formed from any of a variety of suitable materials including brass, aluminum, bronze, copper, plastic, fiberglass, and/or a variety of other suitable materials or combinations thereof. In an exemplary embodiment of the present invention, valve body 10, cap 18, and plunger 36 can be formed from brass and retaining ring 46 and the biasing member can be formed from stainless steel. The particular materials, of course, would be chosen to best match the application involved and the fluids and pressures contemplated.

As further shown in FIGS. 2 and 5, an exemplary valve 11 might include a filter or screen 48 in order to prevent debris and particulate from accessing plunger 36 during use of valve 11. Screen 48 can be associated with valve 11 in any of a variety of specific configurations, but is depicted in FIGS. 2 and 5 as being secured between two retaining rings 50, whereby retaining rings 50 are configured to secure themselves within channels (e.g., 56 in FIG. 5) disposed internally to valve body 10. In one exemplary embodiment of the present invention, screen 48 and retaining rings 50 are formed from stainless steel. However, it should be understood that in alternate embodiments, screen 48 and/or retaining rings 50 can be formed from any of a variety of materials, including brass, aluminum, bronze, copper, plastic, fiberglass, and or a variety of other suitable materials or combinations thereof. It should be further understood that a screen or other filtering arrangement might additionally or alternatively be associated with valve 11 through use of adhesives or other mechanical fastening configurations, and perhaps without the use of one or more retaining rings 50.

A top view of valve body 10 is depicted in FIG. 3, but screen 48 and retaining rings 50 have been removed for clarity. An inlet wall 58 is shown as circumscribing the interior of valve body 10 near inlet 12, and thereby defining a fluid inlet chamber 40 of valve body 10 provided adjacent to first end 86 of valve 11. Situated about the periphery (e.g., adjacent to the outer edge of the bottom wall 41) of fluid inlet chamber 40 are one or more passages (e.g., 52) through valve body 10 that provide fluid communication between fluid inlet chamber 40 and an actuation chamber 64 (shown in FIGS. 4-5). These passages may be present such as when actuation chamber 64 is distinct and spaced from fluid inlet chamber 40 and is provided adjacent to second end 88 of valve 11. Although a plurality of similarly sized and configured passages (e.g., 52) are depicted in FIG. 3, it should be understood that fewer or additional passages might be formed within valve body 10, and that each respective passage can assume any of a variety of suitable sizes and configurations. For example, in one alternate embodiment, a single passage might be provided between fluid inlet chamber 40 and actuation chamber 64, whereby this single passage might have an elongated half-moon or arcuate configuration. The passage(s) can be sufficiently dimensioned such that no appreciable pressure change is induced between fluid inlet chamber 40 and actuation chamber 64 during use of valve 11.

The passages (e.g., 52) can be seen extending through the bottom of valve body 10 in FIGS. 4 and 5. In use of valve 11, fluid would flow from fluid inlet chamber 40 through the passages (e.g., 52) in direction F₁ and out through the bottom of valve body 10. When valve 11 is fully assembled, fluid expelled from the passages (e.g., 52) reflects off the interior surface corresponding to the end wall (e.g., 19 shown in FIG. 2) of cap 18 and then upwardly in direction F₂ within actuation chamber 64 of valve body 10. Hence, pressure within actuation chamber 64 is provided by fluid received at fluid inlet chamber 40.

Plunger 36 can be disposed within actuation chamber 64 and is illustrated as being configured for selective movement between open and closed positions. In its fully opened position, plunger 36 remains abutted against retaining ring 46 under force from an associated biasing member. In its closed position, plunger 36 is moved against the force of the biasing member and becomes seated against the sealing surface 76 of the frustoconical chamber 62 (shown in FIG. 5), thereby preventing fluid from flowing from actuation chamber 64 to outlet 32. Sealing surface 76 can be situated adjacent to actuation chamber 64 and can be configured to correspond with and effectively seal with at least a portion of plunger 36 in its closed position to block fluid communication from fluid inlet chamber 40 to outlet 32.

Plunger 36 overcomes the predetermined force of the biasing member and can move into its closed position when pressure in actuation chamber 64 reaches a predetermined pressure setpoint (described below). More particularly, when the pressure of fluid within actuation chamber 64 is lower than the predetermined pressure setpoint, the fluid passes around plunger 36, through frustoconical chamber 62, into the spring chamber 60, and then through outlet 32. However, when the pressure of this fluid exceeds the predetermined pressure setpoint, plunger 36 moves from its opened position to its closed position, and thereby prevents fluid communication between fluid inlet chamber 40 and outlet 32.

The predetermined pressure setpoint is the inlet fluid pressure at which plunger 36 moves from its open position to its closed position, thereby preventing fluid communication through valve 11. For example, in a vapor recovery condensation application for fuel products, a valve 11 having a predetermined pressure setpoint of between about 4 PSI (27.6 kPa) and about 6 PSI (41.4 kPa) (this range hereinafter referred to as “4-6 PSI”) can facilitate fluid communication through valve 11 when the inlet fluid pressure is less than 4-6 PSI, but can prevent fluid communication through valve 11 when the inlet fluid pressure exceeds 4-6 PSI. Hence, the plunger of such a valve can seal in its closed position against the sealing surface of the valve body when the pressure in the actuation chamber reaches about 4-6 PSI. The predetermined pressure setpoint is typically selected based upon specific application requirements, and can be implemented upon an exemplary valve by adjusting the specific characteristics of the valve's biasing member, plunger, and valve body. As another example, a valve might have a predetermined pressure setpoint of between about 1 PSI (6.89 kPa) and about 2 PSI (13.8 kPa). However, it should be understood that an exemplary valve can be designed in accordance with the present invention to have virtually any predetermined pressure setpoint, and in some applications might even be provided with a user-adjustable predetermined pressure setpoint (e.g., involving a variable or replaceable biasing member).

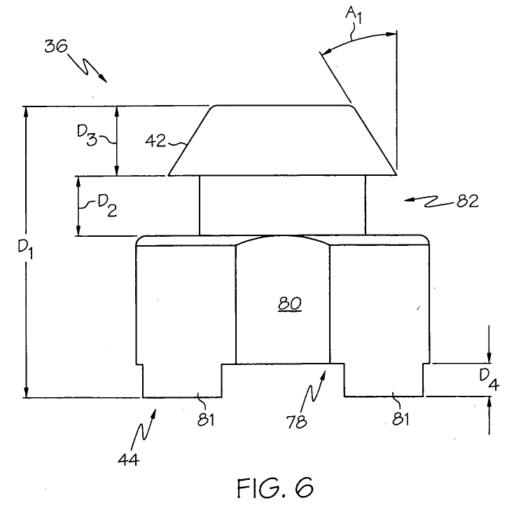

Plunger 36 accordingly acts as a pressure sensing mechanism of valve I1. As pressure increases within valve body 10, plunger 36 is directly contacted by fluid within actuation chamber 64 and is pushed toward its closed position. When in its closed position, plunger 36 (e.g., mating surface portion 42, as shown in FIG. 6) directly interfaces sealing surface 76 of valve body 10. In certain embodiments, this interface constitutes a durable metal-to-metal contact that substantially prevents fluid communication through valve 11. Complete prevention of fluid communication through this metal-to-metal interface is not always possible, although many condensation applications do not require a complete prevention of fluid communication, provided that substantial prevention is achieved. However, complete fluid blockage is achievable in some exemplary valve embodiments. For example, if complete fluid blockage is required while plunger 36 is closed, a channel portion (e.g., 82 in FIG. 6) of plunger 36 may be fitted with additional sealing features, such as an o-ring, to augment the seal. This o-ring could be configured to engage sealing surface 76 when plunger 36 is in its closed position. However, if the same predetermined pressure setpoint is desired from a valve having this modified plunger, it should be understood that certain dimensions/characteristics of the plunger, the biasing member and/or the valve body might require alterations in order to account for the changes in plunger weight, seal friction and/or flow characteristics resulting from the o-ring addition.

As previously indicated, fluid inlet chamber 40 can be oriented to receive fluid and can pass this fluid through passages (e.g., 52) in a first flow direction (e.g., F₁) . However, in the example of FIG. 5, this fluid passes through actuation chamber 64 and toward outlet 32 in a second flow direction (e.g., F₂). In an inverted valve design, as depicted in FIG. 5, the first flow direction F₁ can be different (e.g., opposite) from the second flow direction F₂. Hence, in this inverted valve design, plunger 36 can be oriented for movement toward its closed position in a direction different (e.g., opposite) than the direction of fluid flow through the inlet (i.e. first flow direction F₁). In use, an inverted valve design can be configured such that the first flow direction F₁ is directed vertically downwardly and the second flow direction F₂ is directed vertically upwardly. In such a configuration, the inverted valve design 11 can facilitate fluid communication even during failure of the biasing member because gravity can help maintain plunger 36 in its open position provided that inlet pressures are sufficiently low. Failure of plunger 36 toward its open position also helps ensure that an associated accumulator vessel does not overfill. In some applications, overfilling can cause damage to upstream components (e.g., a condenser or a filter membrane). If a valve were oriented such that the plunger closes by moving downwardly, the plunger could become “stuck” in its closed position such as by a failure of the biasing member, and could accordingly allow an associated accumulator vessel to overfill. Of course, it should be understood that an exemplary valve can be successfully used in virtually any orientation, although the plunger might not fail in a direction toward its open position unless the valve is oriented such that the plunger opens by moving downwardly (as described above with respect to the valve 11 of FIG. 5) or by moving at an angle that is at least partially downwardly directed (e.g., has a downward vector).

In addition to using the pressure of incoming fluid to open and close a plunger, valve 11 facilitates use of residual pressure within an associated accumulator vessel to assist in draining the accumulator vessel faster than would a natural gravity drain. For example, plunger 36 might desirably be biased normally open at atmospheric pressure. As the fluid pressure rises, plunger 36 begins to close against the force exerted by the biasing member. When plunger 36 closes entirely, drainage stops and fluid begins to collect in the accumulator tank. When the compressor cycles off and fluid pressure begins to decrease, the pressure on plunger 36 falls below the force exerted by the biasing member, and plunger 36 resultantly opens. As there is pressure remaining in the system, the pressure forcefully evacuates the vessel. Hence, using the system pressure in this manner to drain the fluid allows the exit piping to not necessarily require a downward slope away from the valve to ensure proper drainage.

As a further instructive example, in order to construct a valve having a predetermined pressure setpoint of 4-6 PSI, specific dimensions can be implemented within valve 11. As sizing of the elements and materials can be important in properly designing a valve to operate optimally, it is believed that this example can assist in applying the invention to a variety of applications and embodiments. In this example, inlet 12 can comprise a male ¾″ National Pipe Threaded end (or its metric equivalent) for insertion into an accumulator vessel, and five passages (e.g., 52) can be provided within a brass valve body 10 between fluid inlet chamber 40 and actuation chamber 64. Each of these five passages can have a diameter of about 0.109″ (2.77 mm) and can extend about 1.9375″ (49.213 mm) in length. When a brass cap 18 is fully threaded onto valve body 10, a gap of about 0.25″ (6.35 mm) separates the passages in valve body 10 from the interior of the end wall 19 of cap 18. This separation enables fluid escaping from the passages to reflect from cap 18 into actuation chamber 64.

In this example, actuation chamber 64 has a width D₁₅ and a height D₁₃. D₁₅ can be about 0.626″ (15.9 mm) with a tolerance of about +0.005″/−0.000″ (+0.13 mm/−0.000 mm) and D₁₃ can be about 0.487″ (12.4 mm) with a tolerance of about ±0.005″ (0.13 mm). Frustoconcial chamber 62 has a height D,₂ of about 0.316″ (8.03 mm) with a tolerance of about ±0.005″ (0.13 mm) and an angular displacement A₂ of about 30°. Spring chamber 60 has a width D₁₄ and a height D₁₁, wherein D₁₄ can be about 0.266″ (6.76 mm) with a tolerance of about ±0.005″ (0.13 mm) and D₁₁ can be about 0.654″ (16.6 mm) with a tolerance of about ±0.005″ (0.13 mm). Spring 34 can have an uncompressed length of about 1.38″ (35.1 mm), an outside diameter of about 0.24″ (6.1 mm), and a spring constant of about 2.5 lbs/in (438 N/m). Such a spring can be formed from stainless steel, and is presently available such as, for example, from Century Spring Corporation as part number 70596S.

Reference will now be made to FIGS. 6-8 which depict characteristics of an appropriate brass plunger 36 for use with the aforementioned valve body 10 and spring 34 in achieving the desired predetermined pressure setpoint of 4-6 PSI. Plunger 36 is shown to comprise a pressure surface 44 configured to be directly impacted by the pressure of fluid flowing in direction F₂ within actuation chamber 64. Bottom channels 78 are provided on pressure surface 44 for directing received fluid onward for passage along four respective side channels (e.g., 80) cut into plunger 36. The depth of bottom channels 78 into plunger 36 is labeled D₄ and the widths of bottom channels are labeled D₇. D₄ can measure about 0.070″ (1.78 mm) and D₇ can measure about 0.250″ (6.35 mm), both of which have tolerances of about ±0.005″ (0.13 mm). As a result of bottom channels 78, four extensions 81 can be provided by pressure surface 44 of plunger 36. The largest outer circumference of plunger 36 is D₁₀, but the outer circumference is reduced to D₈ across the portions of plunger 36 having side channels (e.g., 80). In this example, D₁₀ can measure about 0.621″ (15.8 mm) and D₈ can measure about 0.591″ (15.0 mm), both of which have tolerances of about ±0.002″ (0.051 mm).

The overall height of this exemplary plunger 36 can be D₁, wherein portions of that height (i.e., D₂ and D₃) correspond to a channel portion 82 and a mating surface portion 42 of plunger 36, respectively. More particularly, D₁ can measure about 0.620″ (15.7 mm), D₂ can measure about 0.125″ (3.18 mm) and D₃ can measure about 0.345″ (8.76 mm), all of which have tolerances of about ±0.005″ (0.13 mm). Mating surface portion 42 has an angular displacement A₁ of about 30°. The outer circumference D₉ corresponding with channel portion 82 can measure about 0.340″ (8.64 mm) with a tolerance of about ±0.005″ (0.13 mm). Plunger 36 is also provided with a recess 84 for reception of a portion of spring 34. Recess 84 can have a width D₅ and a height D₆. In order to achieve the predetermined pressure setpoint of between 4-6 PSI, D₅ can measure about 0.266″ (6.76 mm) and D₆ can measure about 0.341″ (8.66 mm), both of which can have a tolerance of about ±0.005″ (0.13 mm).

Outlet 32 of this exemplary valve 11 comprises a ⅛″ National Pipe Threaded female aperture (or its metric equivalent). Between about 36″ (0.91 m) to about 40″ (1.0 m) of copper tubing is connected at its first end to outlet 32 through fitting 20. This copper tubing can have an internal diameter of about 0.248″ (6.30 mm) and can be routed such that its second end drains into an underground storage tank that is maintained substantially at atmospheric pressure. This copper tubing configuration imposes some resistance upon fluid flowing from valve 11 to the storage tank, and resultantly imposes some back-pressure upon valve 11. The foregoing description and dimensions are merely exemplary for providing a valve having a ⅛″ National Pipe Threaded output (or its metric equivalent), a predetermined pressure setpoint of 4-6 PSI, and the above-recited outlet connections with corresponding resistance and back-pressure. It should be understood that a valve in accordance with the teachings herein might alternatively have higher or lower flow capacities (e.g., with larger or smaller inlets/outlets), might have different outlet flow resistances, and/or might have differing predetermined pressure setpoints. Of course, in any such alternative valve assemblies, the precise configurations and/or dimensions of the plunger, biasing member and/or valve body might vary as appropriate and as will be appreciated by those skilled in the art.

An exemplary valve in accordance with the present invention can be used to facilitate selective fluid communication of any of a variety of fluids, including hydrocarbons (e.g., petroleum products such as gasoline, diesel, or other fuel), non-hydrocarbons, volatile or non-volatile chemicals or fluids, and/or any of a variety of other fluids in gaseous and/or liquid form. Also, an exemplary valve in accordance with the present invention can be integrated into or used in conjunction with many types of systems, including condenser systems, for example. Exemplary condenser systems can include air conditioning systems, chemical manufacturing systems, and recovery systems (e.g., for vapor recovery of fuels), and/or other environmental applications.

One specific application for an exemplary valve constructed in accordance with the teachings of the present invention, involves a pressure management system for a fuel (e.g., gasoline) storage tank. This pressure management system can include a compressor and a condenser, among other components. The compressor may be a motor-driven rotary vane pump, a diaphragm or any other type of pressure pump that selectively withdraws air/vapor from a fuel storage tank (e.g., an underground or aboveground storage tank at a gas station). The compressor compresses and heats air/vapor from the storage tank, and the compressed air/vapor is then propelled to the condenser. The condenser cools the air/vapor (e.g. with ambient or chilled air) to form a partially condensed air/vapor/liquid. The air/vapor/liquid is then moved to an accumulator vessel, which can be any structure that provides for accumulation of fluid, including, but not limited to a conventional pipe or a welded or cast tank (e.g., formed from aluminum). In one embodiment, the air/vapor/liquid naturally separates into liquid and air/vapor mixture components in the accumulator vessel. In another embodiment, the inlet of the accumulator vessel is configured to slow the air/vapor/liquid as it enters the accumulator vessel to allow the liquid to “drop out” of the air/vapor/liquid and collect at the bottom of the accumulator vessel. In yet another embodiment, the air/vapor/liquid may be physically separated in the accumulator vessel through the use of steel mesh, hydrocarbon membranes or other conventional liquid/gas separation arrangements.

The overall pressure inside the accumulator vessel increases proportionally as the volume of air/vapor mixture and liquid within the accumulator vessel increases, often reaching 20-50 PSI (138-345 kPa) in a gasoline pressure management system application. However, pressure in the accumulator vessel decreases when the air/vapor mixture and liquid are released from the accumulator vessel. An accumulator vessel can be provided with one or more outlets for releasing the air/vapor and liquid. Either a single outlet might be provided for both the air/vapor and liquid, or separate outlets might be provided for each. A single valve 11 can be associated with one or more such outlet(s) from the accumulator vessel. Valve 11 can remain closed when the pressure pump of the vapor condensing system is in operation (i.e., when the pressure within the accumulator vessel exceeds a predetermined pressure of 4-6 PSI). When the pressure pump stops, pressure within the accumulator vessel eventually subsides below the predetermined pressure setpoint of 4-6 PSI, and valve 11 opens thereby releasing condensed liquid and any remaining air/vapor to. the storage tank.

In use, the tank pressure management system can operate cyclically in order to control vapor expansion and resultant pressure increases in the storage tank. For example, in one embodiment, the compressor may run continuously for about ten minutes. After about ten minutes, the compressor can shut down for at least two minutes. During this shutdown, pressure within the accumulator vessel should bleed from the accumulator vessel until the predetermined pressure setpoint is reached. A properly designed system can facilitate this bleeding in order that the predetermined setpoint can be reached between cycles such that valve 11 can accordingly open. This bleeding can be provided by inherent system losses (e.g., leaks) or by specifically designed bleeder mechanisms, for example. When the predetermined pressure setpoint is reached, valve 11 opens and the accumulator vessel can drain through valve 11 into the storage tank, thereby completing a cycle. The compressor can then resume operation at predetermined intervals, and/or when and if the tank pressure again becomes excessive. It should be understood that longer/shorter cycle times can be achieved by adjusting the capacity of the accumulator vessel as appropriate.

The foregoing description of exemplary embodiments and examples of the invention has been presented for purposes of illustration and description. It is not intended to be exhaustive or to limit the invention to the forms described. Numerous modifications are possible in light of the above teachings. Some of those modifications have been discussed, and others will be understood by those skilled in the art. The embodiments were chosen and described in order to best illustrate the principles of the invention and various embodiments as are suited to the particular use contemplated. Rather, it is hereby intended that the scope of the invention be defined by the claims appended hereto.

1. A pressure actuated valve comprising:
a valve body comprising first and second ends and having a fluid inlet chamber, an actuation chamber and an outlet, the chambers and the outlet being configured for selective fluid communication with one another, the fluid inlet chamber being provided adjacent to one of the first and second ends, and the actuation chamber being provided adjacent to the other of the first and second ends;
a plunger disposed within at least a portion of the actuation chamber for selective movement between open and closed positions;
a sealing surface situated adjacent to the actuation chamber and correspondingly configured to effectively seal with the plunger in its closed position to block fluid communication between the fluid inlet chamber and the outlet;
a biasing member associated with the plunger and configured to normally bias the plunger toward its open position;
wherein the plunger is configured to move into its closed position when pressure in the actuation chamber reaches a predetermined pressure setpoint.

2. The valve of claim 1 wherein the outlet is disposed between the first and second ends.

3. The valve of claim 1 further comprising a cap associated with the other of the first and second ends, the cap being operative to seal the other of the first and second ends.

4. The valve of claim 1 further comprising a retaining ring associated with the valve body, the retaining ring being configured to retain at least a portion of the plunger within the actuation chamber when the plunger is in its open position.

5. The valve of claim 1 wherein the actuation chamber is distinct from the fluid inlet chamber.

6. The valve of claim 5 wherein the actuation chamber is spaced from the fluid inlet chamber.

7. The valve of claim 5 further comprising at least one passage in the valve body, said passage being configured to provide fluid communication between the fluid inlet chamber and the actuation chamber.

8. The valve of claim 1 wherein the fluid inlet chamber is configured to receive fluid in a first flow direction, and the actuation chamber is configured to pass fluid in a second flow direction, the first flow direction being different from the second flow direction.

9. The valve of claim 8 wherein the first flow direction is opposite from the second flow direction.

10. The valve of claim 9 wherein the plunger is configured for movement toward its closed position in the same direction as the second flow direction.

11. The valve of claim 8 wherein the plunger is configured for movement toward its closed position in a direction different from the first flow direction.

12. The valve of claim 11 wherein the plunger is configured for movement toward its closed position in a direction opposite from the first flow direction.

13. The valve of claim 1 wherein the predetermined pressure setpoint is selected from ranges consisting of between about 1 PSI (6.89 kPa) and about 2 PSI (13.8 kPa), and between about 4 PSI (27.6 kPa) and about 6 PSI (41.4 kPa).

14. A pressure actuated valve comprising:
a valve body comprising first and second ends and having a fluid inlet chamber, an actuation chamber and an outlet, the chambers and the outlet being configured for selective fluid communication with one another, the fluid inlet chamber being oriented to receive fluid in a first flow direction, the fluid inlet chamber being provided adjacent to one of the first and second ends, the actuation chamber being spaced from the fluid inlet chamber and being provided adjacent to the other of the first and second ends, the actuation chamber being configured to pass fluid in a second flow direction, the second flow direction being different from the first flow direction;
a passage in the valve body providing fluid communication between the fluid inlet chamber and the actuation chamber;
a plunger disposed within at least a portion of the actuation chamber for selective movement between open and closed positions, the plunger being configured for movement toward its closed position in the same direction as the second flow direction;
a sealing surface being situated adjacent to the actuation chamber and being correspondingly configured to effectively seal with the plunger in its closed position to block fluid communication between the fluid inlet chamber and the outlet;
a biasing member being associated with the plunger and configured to normally bias the plunger toward its open position;
wherein the plunger is configured to move into its closed position upon pressure in the actuation chamber reaching a predetermined pressure setpoint.

15. The valve of claim 14 wherein the outlet is disposed between the first and second ends.

16. The valve of claim 14 further comprising a cap associated with the other of the first and second ends, the cap being operative to seal the other of the first and second ends.

17. The valve of claim 14 further comprising a retaining ring associated with the valve body, the retaining ring being configured to retain at least a portion of the plunger within the actuation chamber when the plunger is in its open position.

18. The valve of claim 14 wherein the first flow direction is opposite from the second flow direction.

19. The valve of claim 14 wherein the predetermined pressure setpoint is selected from ranges consisting of between about 1 PSI (6.89 kPa) and about 2 PSI (13.8 kPa), and between about 4 PSI (27.6 kPa) and about 6 PSI (41.4 kPa).

20. A condenser system for a fuel storage tank system, the condenser system having a pressure actuated valve for selectively releasing condensed fuel, the valve comprising:
a valve body having a fluid inlet chamber, an actuation chamber, and an outlet, the chambers and the outlet being configured for selective fluid communication with one another;
a plunger disposed within at least a portion of the actuation chamber for selective movement between open and closed positions;
a sealing surface situated adjacent to the actuation chamber and correspondingly configured to effectively seal with the plunger in its closed position to block fluid communication between the fluid inlet chamber and the outlet;
a biasing member associated with the plunger and configured to normally bias the plunger toward its open position;
wherein the plunger is configured to move into its closed position when pressure in the actuation chamber reaches a predetermined pressure setpoint.

21. The condenser system of claim 20 wherein the valve body comprises first and second ends, the fluid inlet chamber being provided adjacent to one of the first and second ends, and the actuation chamber being provided adjacent to the other of the first and second ends.

22. The condenser system of claim 21 wherein the outlet is disposed between the first and second ends.

23. The condenser system of claim 21 further comprising a cap associated with the other of the first and second ends, the cap being operative to seal the other of the first and second ends.

24. The condenser system of claim 21 further comprising a retaining ring associated with the valve body, the retaining ring being configured to retain at least a portion of the plunger within the actuation chamber when the plunger is in its open position.

25. The condenser system of claim 21 wherein the actuation chamber is spaced from the fluid inlet chamber, fluid communication being provided between the fluid inlet chamber and the actuation chamber through at least one passage in the valve body.

26. The condenser system of claim 21 wherein the fluid inlet chamber is configured to receive fluid in a first flow direction, and the actuation chamber is configured to pass fluid in a second flow direction, the first flow direction being different from the second flow direction.

27. The condenser system of claim 26 wherein the first flow direction is opposite from the second flow direction.

28. The condenser system of claim 26 wherein the plunger is configured for movement toward its closed position in a direction opposite from the first flow direction.

29. The condenser system of claim 21 wherein the predetermined pressure setpoint is selected from ranges consisting of between about 1 PSI (6.89 kPa) and about 2 PSI (13.8 kPa), and between about 4 PSI (27.6 kPa) and about 6 PSI (41.4 kPa).
